(19) United States
(12) Patent Application Publication
(10) Pub. No.: US 2018/0145450 A1
(43) Pub. Date: May 24, 2018

(54) PLUG CONNECTOR ASSEMBLY HAVING IMPROVED LOCKING STRUCTURE

(71) Applicant: FOXCONN INTERCONNECT TECHNOLOGY LIMITED, Grand Cayman (KY)

(72) Inventors: JERRY WU, New Taipei, CA (US); JUN CHEN, Kunshan (CN); XIAO FAN, Kunshan (CN); ZHI-YONG ZHOU, Kunshan (CN)

(21) Appl. No.: 15/817,319

(22) Filed: Nov. 20, 2017

(30) Foreign Application Priority Data
Nov. 23, 2016 (CN) 201611040949.X

(51) Int. Cl. H01R 13/627; H01R 13/635; H01R 13/506

(52) U.S. Cl. CPC H01R 13/6273; H01R 13/506; H01R 13/635

(57) ABSTRACT

A plug connector assembly includes: a mating member including an insulative housing and a pair of latching members retained in the insulative housing; a cable; and an outer case, wherein the latching member includes a base portion, a fixing portion forwardly extending from the base portion, a connecting portion upwardly extending from the base portion, an elastic portion forwardly and rearwardly extending from an extremely end of the connecting portion, a locking portion disposed on a front side of the elastic portion and exposed to the insulative housing, and a pressing portion downwardly extending from a rear end of the elastic portion beyond the base portion; the outer case defines an operating portion for operating the latching member; the operating portion drives the pressing portion to disengage the latching with a mating connector; and the operating direction of the operating portion is opposite to the movement direction of the locking portion.

### BACKGROUND OF THE INVENTION

### 1. Field of the Invention

The present invention relates generally to a plug connector assembly and more particularly to an improved locking structure for locking with a mating connector.

### 2. Description of Related Arts

U.S. Patent Application Publication No. 2015/0288104, published on Oct. 8, 2015, shows a plug connector assembly including a mating member, a cable electrically connected with the mating member, and an outer case enclosing the mating member and the cable. The mating member includes an insulative housing and a locking member assembled on the insulative housing. The locking member includes a flat base portion, a pair of connecting portions extended from the central portions of both sides of the base portion, a pair of elastic portions upwardly extending from upper ends of the connecting portions, and a pair of fixing portions forwardly and rearwardly extending from the sides of the base portion. Each of the elastic portions defines a locking portion on an end thereof and a pressing portion at a central position thereof. The outer case defines a handle portion arranged with the pressing portion to disengage the locking portions from a mating connector.

Since the locking portion and the handle portion are disposed on a same side, the movement space of the handle portion is too small to disengage the locking portions from the mating connector easily.

An improved locking structure in a plug connector assembly is desired.

### SUMMARY OF THE INVENTION

An object of the present invention is to provide an improved locking structure easy for operating to disengage from a mating connector.

To achieve the above-mentioned object, a plug connector assembly comprises: a mating member including an insulative housing and a pair of latching members retained in the insulative housing; a cable electrically connected to the mating member; and an outer case enclosing the mating member and the cable; wherein the latching member includes a base portion, a fixing portion forwardly extending from the base portion for being fixed on the insulative housing, a connecting portion upwardly extending from the base portion, an elastic portion forwardly and rearwardly extending from an extremely end of the connecting portion, a locking portion disposed on a front side of the elastic portion and exposed to the insulative housing, and a pressing portion downwardly extending from a rear end of the elastic portion beyond the base portion; the outer case defines an operating portion for operating the latching member; the operating portion drives the pressing portion to disengage the latching with a mating connector; and the operating direction of the operating portion is opposite to the movement direction of the locking portion.

### BRIEF DESCRIPTION OF THE DRAWING

FIG. 1 is a perspective view of a plug connector assembly in accordance with the present invention;

FIG. 2 is a partly exploded view of the plug connector assembly in FIG. 1;

FIG. 3 is a partly exploded view similar to FIG. 2, but from a different aspect;

FIG. 4 is a further partly exploded view of the plug connector assembly in FIG. 2;

FIG. 5 is a further partly exploded view of the plug connector assembly in FIG. 4, but from a different aspect;

FIG. 6 is a further partly exploded view of the plug connector assembly in FIG. 4, but removing the cable and the outer case;

FIG. 7 is a further partly exploded view similar to FIG. 6, but from a different aspect; and

FIG. 8 is a cross-sectional view taken along line 9-9 in FIG. 1.

### DETAILED DESCRIPTION OF THE PREFERRED EMBODIMENT

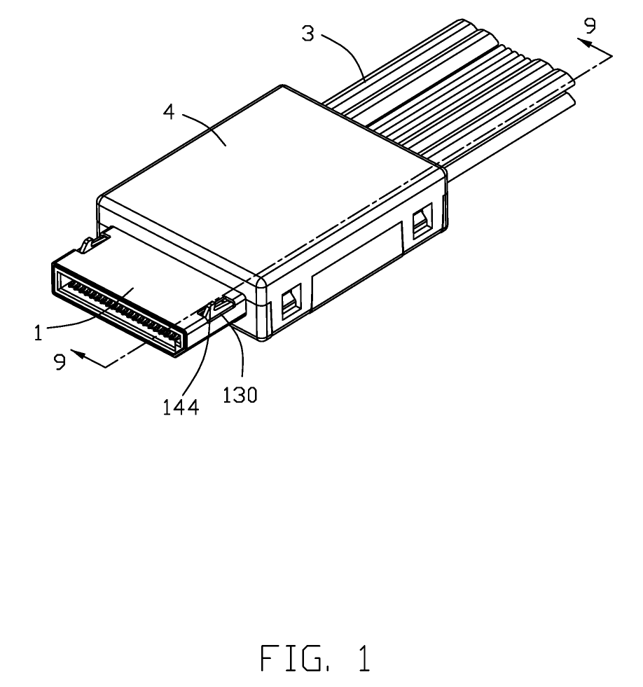

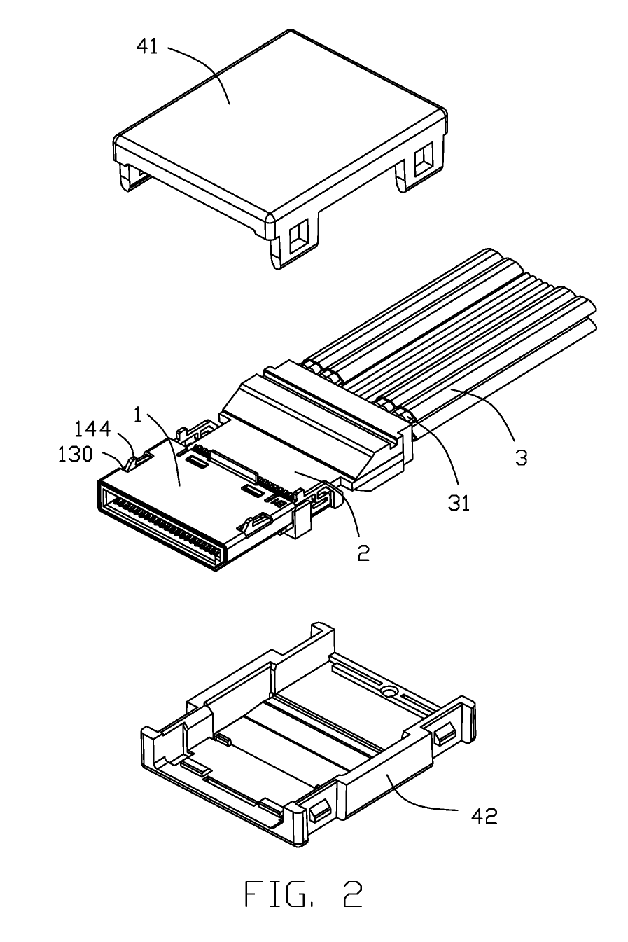

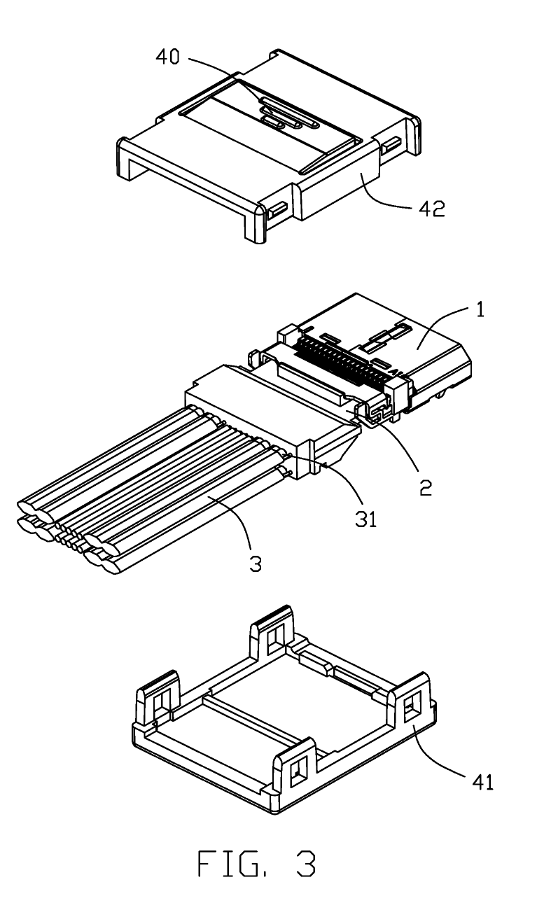

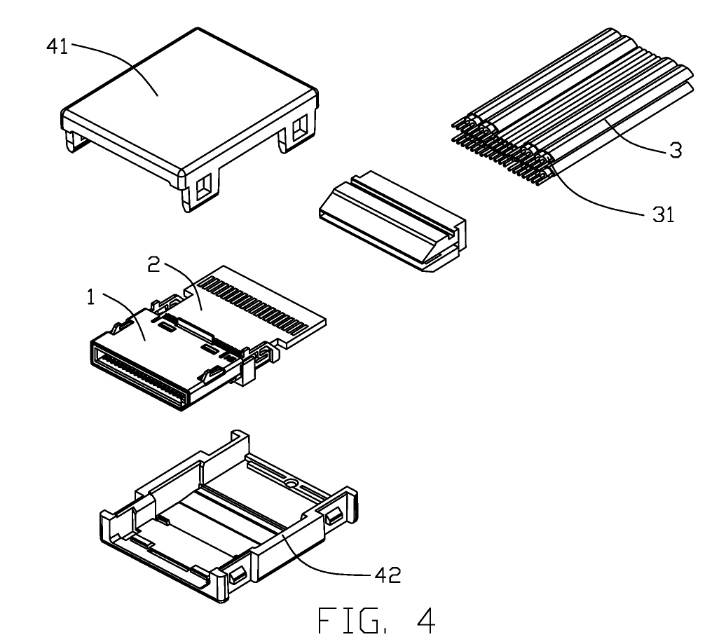

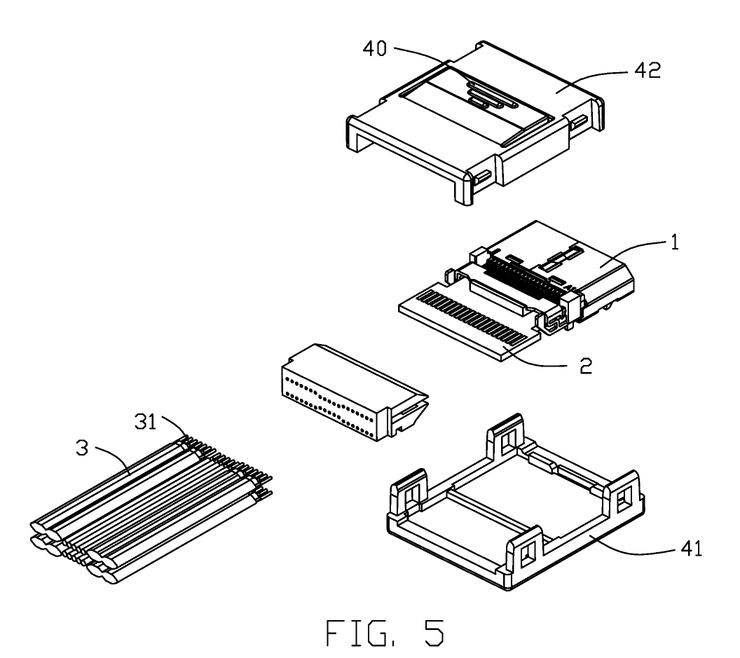

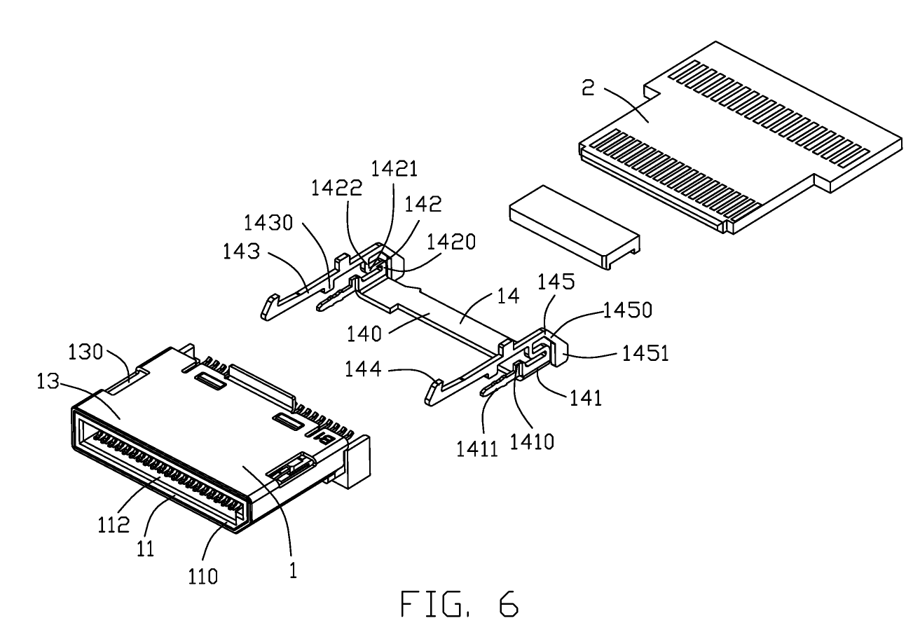

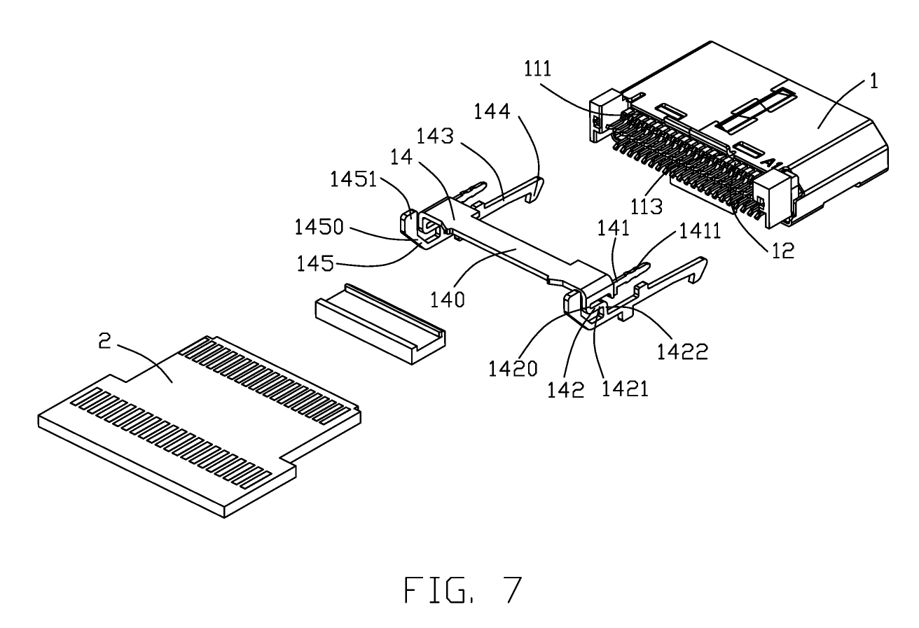

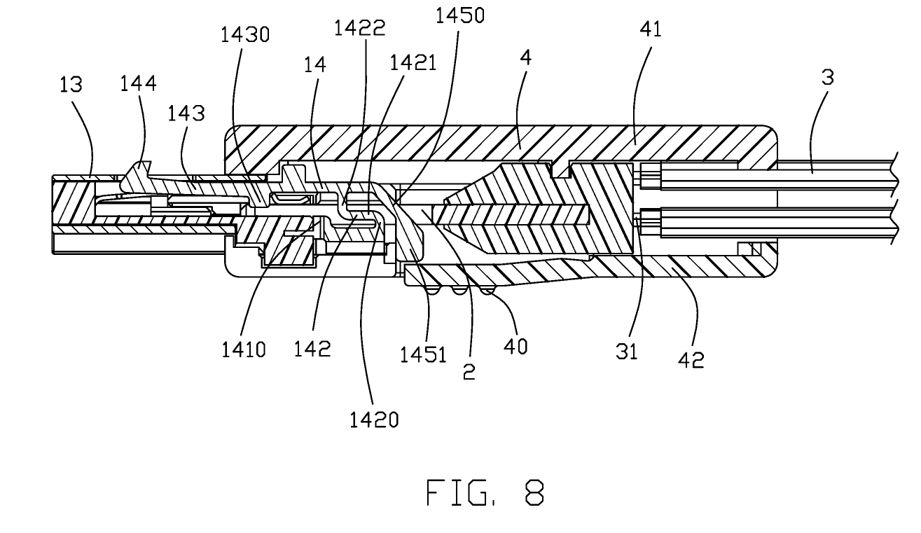

Referring to FIGS. 1 to 8, a plug connector assembly 100 in accordance with the present invention for latching with a mating connector (not shown), comprises a mating member 1, a printed circuit board 2 electrically connected to the mating member 1, a cable 3 electrically connected with the printed circuit board 2, and an outer case 4 enclosing the mating member 1 and cable 3. The printed circuit board 4 is connected to the mating member 1 on an end thereof and connected to the cable 3 on another end thereof. The cable 3 is a flat structure and includes a plurality of core wires 31.

The mating member 1 includes an insulative housing 11, a contacting module 12 retained in the insulative housing 11, a metal case 13 enclosing the insulative housing 11, and a pair of latching members 14 assembled on the mating member 1 for latching with the mating connector.

The insulative housing 11 defines a mating surface 111 disposed on a front end thereof, an opposite mounting surface 111, a mating slot 112 inwardly extending from the mating surface 111, and a mounting slot 113 inwardly extending from the mounting surface 111 and communicating with the mating slot 112.

The metal case 13 surrounds the insulative housing 11, exposing the mating surface 110 and the mounting surface 111 to outside thereof. The metal case 13 defines a pair of through holes 130 on a side thereof.

The latching member 14 includes a base portion 140, a pair of fixing portions 141 spaced and forwardly extending from the base portion 140, a pair of connecting portions 142 spaced and upwardly extending from the base portion 140, a pair of elastic portions 143 forwardly and rearwardly extending from an extremely end of the corresponding connecting portion 142 respectively, a pair of locking portions 144 disposed on a front end of the corresponding elastic portion 143 and exposed to the insulative housing 11, and a pair of pressing portions 145 downwardly extending from a rear end of the corresponding elastic portion 143 and beyond the base portion 140.

The fixing portion 141 is fixed on the insulative housing 11. Each of the fixing portions 141 defines a stopping portion 1410 extending upwardly there from, to prevent the corresponding fixing portions 141 from being inserted into the insulative housing 11 excessively. Each of the fixing portions 141 defines a plurality of barbs 1411 to reinforce the holding of the corresponding fixing portions 141 with the insulating body.

Both of the connecting portions 142 are angled structures, more specifically, each of the connecting portions 142 includes a first vertical portion 1420 upwardly extending from the base portion 140, a horizontal portion 1421 forwardly extending from the vertical portion 1420, and a second vertical portion 1422 upwardly extending from the horizontal portion 1421 to connect with the elastic portion 143.

Each of the elastic portions 143 defines a limiting portion 1430 disposed on a front side of the corresponding connecting portion 142 and downwardly extending from the corresponding elastic portion 143, for preventing the corresponding elastic portion 143 from being excessively pressed. The pair of locking portions 144 is passed through the corresponding through holes 130 to be exposed to the outer side of the metal case 13, for locking with the mating connector.

Each of pressing portion 145 includes an extending portion 1450 rearwardly and obliquely downwardly extending from a rear end of the corresponding connecting portion 142, and a pressure portion 1451 downwardly extending from an extremely end of the extending portion 1450. The width of the pressure portion 1451 is greater than the width of the extending portion 1450.

The outer case 4 includes a first case 41 and a second case 42 engaging with the first case 41 by snap-in way. The outer case 4 defines an operating portion 40 on an opposite side relative to the locking portion 144 of the latching member 14, for operating the latching member 14. Operators press the operating portion 40 to apply a force to the pressure portion 1451, and then further drive the locking portion 144 to move toward the inside of the insulative housing 11, finally disengage the latching with the mating connector. The operating direction of the operating portion 40 is opposite to the moving direction of the locking portion 144.

Compared to the prior art, the operating portions 40 and the locking portions 144 of the plug connector assembly 100 of the present invention are disposed on opposite sides, thus, the locking portions 144 have a large movement space, and it is easy to release the latching of the mating connector.

What is claimed is:

1. A plug connector assembly comprising:
a mating member including an insulative housing and a pair of latching members retained in the insulative housing;
a cable electrically connected to the mating member; and
an outer case enclosing the mating member and the cable; wherein
the latching member includes a base portion, a fixing portion forwardly extending from the base portion for being fixed on the insulative housing, a connecting portion upwardly extending from the base portion, an elastic portion forwardly and rearwardly extending from an extremely end of the connecting portion, a locking portion disposed on a front side of the elastic portion and exposed to the insulative housing, and a pressing portion downwardly extending from a rear end of the elastic portion beyond the base portion;
the outer case defines an operating portion for operating the latching member;
the operating portion drives the pressing portion to disengage the latching with a mating connector; and
the operating direction of the operating portion is opposite to the movement direction of the locking portion.

2. The plug connector assembly as claimed in claim 1, wherein the fixing portion defines a stopping portion for preventing the fixing portion from being excessively inserted into the insulative housing.

3. The plug connector assembly as claimed in claim 1, wherein the connecting portion is a bent structure.

4. The plug connector assembly as claimed in claim 3, wherein the connecting portion includes a first vertical portion upwardly extending from the base portion, a horizontal portion forwardly extending from the first vertical portion, and a second vertical portion upwardly extending from the horizontal portion to connect to the elastic portion.

5. The plug connector assembly as claimed in claim 1, wherein the elastic portion defines a downwardly extending limiting portion disposed on a front side of the connecting portion for preventing the elastic portion from being pressed excessively.

6. The plug connector assembly as claimed in claim 1, wherein the pressing portion includes an extending portion rearwardly and obliquely downwardly extending from a rear end of the connecting portion, and a pressure portion continually to extend downwardly from a distal end of the extending portion, and the operating portion of the outer case applies a force to the pressure portion.

7. The plug connector assembly as claimed in claim 6, wherein a width of the pressure portion is greater than a width of the extending portion.

8. The plug connector assembly as claimed in claim 1, wherein the latching member includes a pair of fixing portions.

9. The plug connector assembly as claimed in claim 8, wherein the latching member includes a pair of spaced connecting portions, a pair of elastic portions connecting with the corresponding connecting portions, a pair of locking portions disposed on a front side of the corresponding elastic portion, and a pair of pressing portions extending from a rear end of the corresponding elastic portion.

10. The plug connector assembly as claimed in claim 9, wherein the mating member includes a metal case enclosing the insulative housing, the metal case including a pair of through holes for exposing the corresponding locking portions to outside.
